(19) United States
(12) Patent Application Publication
(10) Pub. No.: US 2013/0251045 A1
(43) Pub. Date: Sep. 26, 2013

(54) METHOD AND DEVICE FOR DETERMINING A MOTION VECTOR FOR A CURRENT BLOCK OF A CURRENT VIDEO FRAME

(71) Applicants: Xiaodong Gu, Beijing (CN); Debing Liu, Beijing (CN); Zhibo Chen, Beijing (CN)

(72) Inventors: Xiaodong Gu, Beijing (CN); Debing Liu, Beijing (CN); Zhibo Chen, Beijing (CN)

(73) Assignee: Thomson Licensing, Issy de Moulineaux (FR)

(21) Appl. No.: 13/991,664

(22) PCT Filed: Dec. 10, 2010
(86) PCT No.: PCT/CN2010/002011

§ 371 Date: Jun. 5, 2013

(51) Int. Cl. H04N 7/36

(52) U.S. Cl. CPC H04N 19/00684
USPC 375/240.16

(57) ABSTRACT

A method for determining a motion vector for a current video frame block comprises determining the motion vector using full search. Then, a number of further motion vectors is counted which is the number of motion vectors of neighbouring blocks which are similar to each other and the motion vector. Then it is ascertained that the number meets or exceeds a threshold and that the motion vector is not similar to at least one of the counted further motion vectors. A search region is determined using counted motion vectors and searched for a local best match of the current block. The motion vector is changed towards referencing the local best match. The search region only comprises candidates referenced by motion vector candidates similar to a yet further motion vector pointing to a centre of the further search region. Then, the motion vector resembles the motion presumed by the HVS.

### TECHNICAL FIELD

The invention is made in the field of motion estimation in video.

### BACKGROUND OF THE INVENTION

Motion estimation in video is useful for, a variety of purposes. A common application of motion estimation is for residual encoding of the video.

Prior to encoding the residual is quantized wherein a quantization parameter is commonly controlled by rate-distortion-optimization (RDO) wherein distortion refers to spatial distortion i.e. the difference between the original block and the block reconstructed from a reconstructed reference block and the quantized residual.

In natural video, neighbouring blocks belonging to a same object have similar or smoothly changing motion vectors. The same is true for neighbouring blocks belonging to a background. Only for edges between objects and background or between different objects, motion vectors can be discontinuous or non-smooth. i.e. not similar. In such case, discontinuous motion is semantically natural.

Discontinuities in general catch the attention of the human visual system (HVS). This is because discontinuitieS at object boundaries are useful for the HVS for identifying objects.

### SUMMARY OF THE INVENTION

As quantization is controlled by RDO based on spatial distortion only, it can occur that blocks in subsequent frames which the HVS perceives as corresponding, i.e. appear correlated by motion, are quantized with different quantization parameters and therefore show different quality. In case the variation exceeds a certain threshold, it represents a discontinuity which catches the attention of the HVS. As this kind of discontinuity result from encoding but not from the video content, it is commonly experienced by a user as a loss of quality. That is, such kind of discontinuity resulting from encoding diminishes the quality of experience (QoE). It represents a temporal distortion also called flicker, an abrupt and un-smooth change of blocks perceived as corresponding caused by coding scheme itself.

The inventors recognized this problem and therefore propose a method for determining a motion vector for a current block of a current video frame according to claim and a corresponding device according to claim 9.

The method comprises determining the motion vector using full search over an entire reference video frame as search region for a global best match of the current block. Then, a number of further motion vectors is counted. The number of further motion vectors is for further blocks neighbouring the current block wherein only those further motion vectors are counted which are similar to the motion vector and which are further similar to each other. The method further comprises ascertaining that the number meets or exceeds a threshold and that the motion vector is not similar to at least one of the counted further motion vectors. Then, the counted further motion vectors are used for determining a further search region. The method also comprises searching, in the further search region, a local best match of the current block and changing the motion vector towards referencing the local best match, the further search region being determined such that all candidates for the local best match are referenced by motion vector candidates similar to a yet further motion vector pointing to a centre of the further search region.

This allows for determining a motion vector which equals or resembles the motion presumed by the HVS.

The features of further advantageous embodiments of the proposed method are specified in the dependent claims.

The motion vector determined according to one of the proposed methods can be used to avoid discontinuities and thus increase the QoE. For instance, RDO can take into account information obtained using such motion vector. Or, the residual which is encoded can be determined using such motion vector. Further, for a given encoding the motion vector determined according one of the proposed methods can be used to evaluate the temporal aspect of QoE of a decoded version of the video.

The invention also proposes a storage medium according to claim 10.

### BRIEF DESCRIPTION OF THE DRAWINGS

Exemplary embodiments of the invention are illustrated in the drawings and are explained in more detail in the following description. The exemplary embodiments are explained only for elucidating the invention, but not limiting the invention's disclosure, scope or spirit defined in the claims.

In the figures:

FIG. 1 exemplarily depicts the difference in between spatial quality evaluation and temporal quality evaluation, in spatial quality evaluation, as exemplarily depicted in the left part of FIG. 1, regarding spatial distortion what humans perceive (static vision) is exactly the digital data in the computer; in temporal quality evaluation, as exemplarily depicted in the middle part of FIG. 1, in temporal distortion what humans perceive (the dynamic vision) is quite different from the digital data in the computer;

FIG. 2 depicts in FIG. 2a a frame of an exemplary decoded video Optis_{—}1280×720_{—}60p; FIG. 2b depicts a sub-area of FIG. 2a and FIG. 2c depicts hexadecimal values of the blocks comprised in the sub-area depicted in FIG. 2b;

FIG. 3 depicts in FIG. 3a the frame of exemplary decoded video Optis_{—}1280×720_{—}60p which follows the frame depicted in FIG. 2a; FIG. 3b depicts a sub-area of FIG. 3a and FIG. 3c depicts hexadecimal values of the blocks comprised in the sub-area depicted in FIG. 3b;

FIG. 4 depicts exemplary indexing of neighbouring blocks; and

FIG. 5 depicts an exemplary flow chart of the proposed scheme for temporal distortion evaluation;

FIG. 6 depicts an exemplary video frame with subjectively marked visible temporal artefact; and

FIG. 7 depicts the exemplary video frame of FIG. 6 with visual artefacts detected based on incoherencies between motion vectors determined according to the invention and motion vectors used for encoding.

### EXEMPLARY EMBODIMENTS OF THE INVENTION

Digital video is composed by a number of discrete frames. In browsing, a continuous video perception is generated in human brain with the received discrete frames by eyes. So in temporal quality evaluation, the evaluated target is the virtual “generated continuous video perception in human brain” while not the physical “discrete frames”.

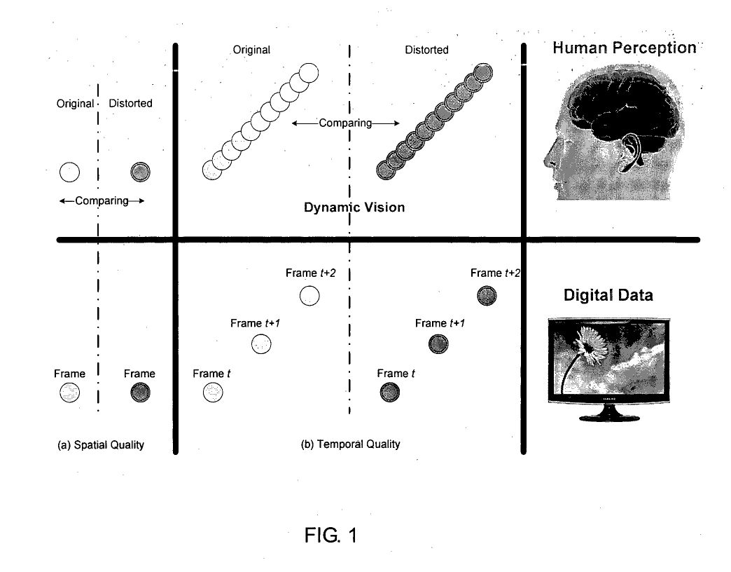

As exemplarily shown in FIG. 1, the human perceived dynamic vision is quite different from the digital data in the computer in that human brain linked the discrete frames into continuous video (according to “apparent movement” theory). The video quality is recognized by the comparing between original and distorted dynamic vision in human brain.

There is still ongoing research regarding the mechanisms of human brain involved in generation of video perception. However, the proposed invention enables, based on the digital data, evaluation of the temporal quality.

In an exemplary embodiment of the invention, the evaluation of temporal quality decreasing introduced by block based coding (e.g. H.264, MPEG2) is examined. The objective of current coding standard is to provide a best tradeoff between compression ratio (Rate) and spatial quality (Distortion). Temporal quality is still out of consideration. Therefore, it is likely that the coding operations trying to optimize R-D will introduce inacceptable temporal quality decreasing.

Such temporal quality decreasing can be caused by different mode selection, for example. In codec like H.264, blocks can be coded in different modes including INTRA, INTER, SKIP etc. In relative static areas, some blocks are coded in SKIP mode which means copy directly from previous frame, especially in low bit-rate coding. Along time, the corresponding blocks in temporal axis are all coded in SKIP mode. And finally, the error accumulated by SKIP mode encoding exceeds a certain threshold and RDO responds in switching from SKIP mode to INTRA mode. Usually viewer will be able to perceive a sudden change/flash, recognized as temporal degradation.

Another example is temporal quality degradation caused by by different frame types: In each GOP, P-frames are referenced from I-frames and B-frames are referenced from I- and P-frames. Errors propagate and accumulate in frames which are far away from the I-frame. Then at the end of the GOP, a new I-frame appears in which the error is re-set to 0. Therefore, sometimes a clear flash/displacement can be perceived at the end of the GOP when the accumulated error is re-set to 0 by the next I-frame. This type of temporal degradation is recognized as “flicker”.

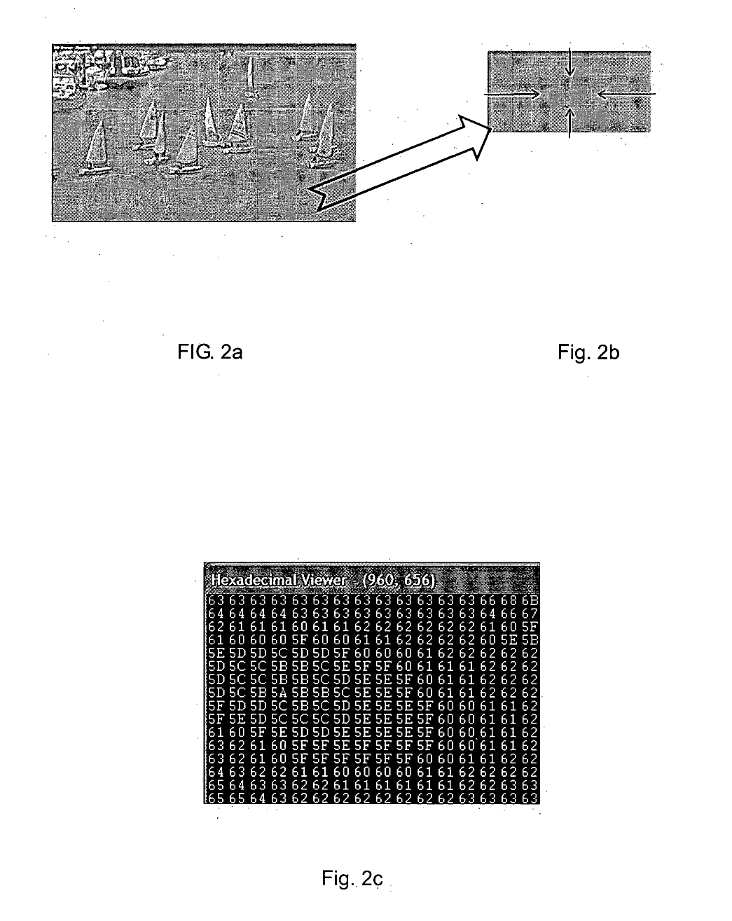

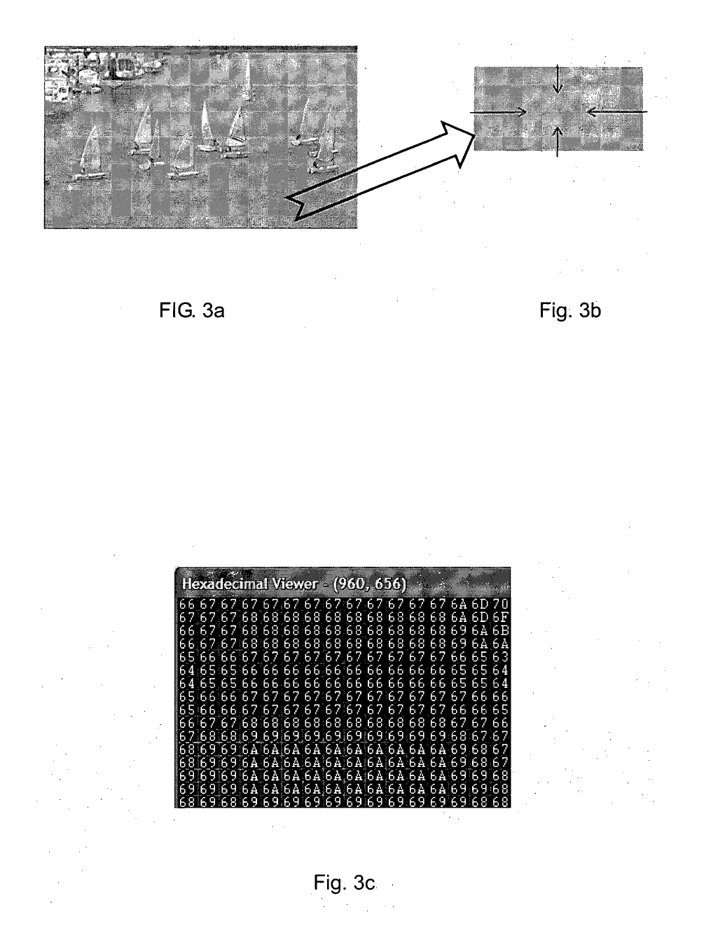

FIG. 2 and FIG. 3 allow for comparing two 16×16 blocks in consecutive frames (frame 15 and frame 16) of exemplary video Optis_{—}1280×720_{—}60p at same spatial position. The hexadecimal values of the intensity of the blocks are shown in FIG. 2c and FIG. 3c. It can be observed in FIGS. 2b and 3b that the block in frame 15 is a little darker than the block in frame 16. The difference arises since the pointed block and its neighboring blocks are all coded in SKIP mode in frame 15, while in frame 16, the neighbouring blocks continue to be coded in SKIP mode while the pointed block is coded in INTRA mode. Though coded in different modes, no obvious spatial distortion is generated in both frame 15 and frame 16. However, when the video is displayed, a clear temporal distortion perceived as a sudden change/flash (frame dark to light) is observed at the pointed block between frame 15 and frame 16.

This kind of block based temporal distortion will heavily decrease the human pleasure in perceiving the video. Therefore it's important to evaluate such kind of temporal distortion in evaluation of QoE or to avoid such kind of temporal distortion in video encoding.

Commonly, videos depict opaque objects of finite size undergoing rigid motion or deformation. In this case neighboring points on the objects have similar velocities and the velocity field of the point in the image varies smoothly almost everywhere. This is called “motion smoothness in neighbourhood” or smoothness constraint. The smoothness constraint is stricter for pixels but has some applicability for blocks which are the basic elements of encoding. Thus, in encoding the smoothness constraint requires that neighbouring blocks depicting the same object have similar (or smoothly changing) velocities—and thus similar motion vectors (MV).

Denote the current video frame f={B_ij, 0≦i<m, 0≦j<n}, B_ij is a block of the frame, indexing from left to right, top to bottom. Denote MV(B_ij) the motion vector of the block, referencing from the previous video frame. Denote B_ijᵥᵢᵣₜᵤₐₗ the block of a preceeding frame which is perceived by the HVS as the block corresponding to block B_ij of a current frame. And denote Dist(B1, B2) the distance measure of two blocks B1 and B2.

In an exemplary embodiment, temporal distortion TDV of a decoded block B_ij is defined as the distance measure between the block and it's predecessor according to the HVS (B_ijᵥᵢᵣₜᵤₐₗ)

TDV(B_{—}ij)=Dist(B_{—}ij,B_{—}ijᵥᵢᵣₜᵤₐₗ) (1)

The following gives an example for determining B_ijᵥᵢᵣₜᵤₐₗ as well as an example for the distance measure function−Dist.

FIG. 5 depicts an exemplary flow chart for determining TDV. The input of the scheme is the video frames while the output of the scheme is TDV. The scheme is composed by two main procedures: ME and MS.

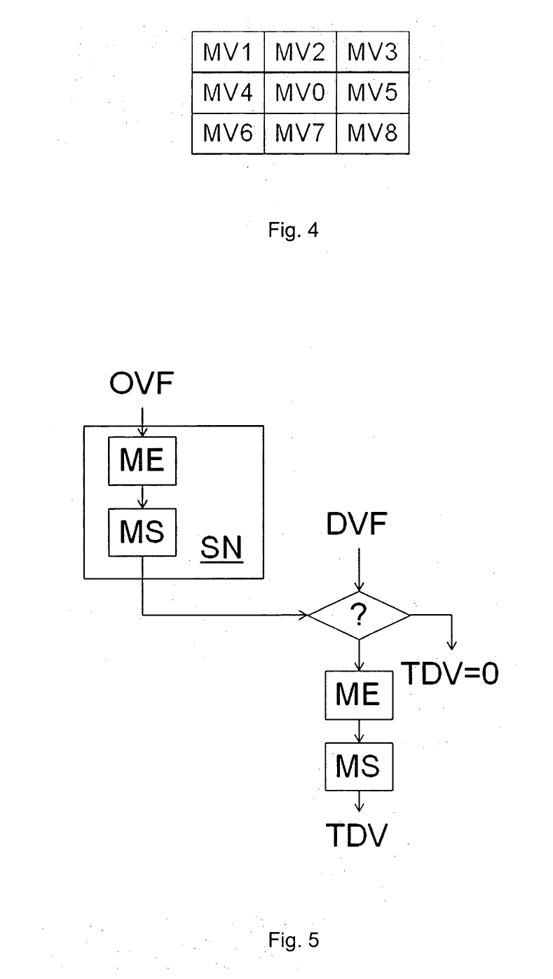

The module Motion Estimation ME is to estimate the motion vector of all the blocks of the video frame, i.e. full search which is a search for the best match among all candidates using a difference measure such a statistical difference (MSE, for example), or a structural difference (e.g. SSIM). This module results in a motion vector MV₀ for the current block and motion vectors MVᵢ (i=1 . . . 8) for its 8-neighboring blocks, as shown in FIG. 4.

The module Motion Smoothness MS generates a virtual motion vector (MVᵥᵢᵣₜᵤₐₗ) by smoothing the motion vector MV₀ of the current block B using the motion vectors MVᵢ (i=1 . . . 8) of the neighbouring blocks. Module MS is based on a similarity criterion defined as follows:

Two motion vectors (MVᵢ and MVⱼ) are judged as similar (denoted as MVᵢ˜MVⱼ) if |MVᵢ^{x}−MVⱼ^{x}|<δ^{x} and |MVᵢ^{y}−MVⱼ^{y}|<δ^{y}, where MVᵢ^{x}, MVᵢ^{y} are the projections of MVᵢ on a first axis (x-axis) and a perpendicular second axis (y-axis), respectively, and δ^{x} and δ^{y} are two constant numbers.

In module MS, the following steps are performed:

Determining whether there is at least one sub-set S={sₜ|sₜε{MV₁, MV₂, . . . , MV₈}; sₘ≈sₙ, ∀sₘ sₙεS; |S|≧c} (c is a predetermined number), for which MV₀˜sₜ, for all sₜεS. If MV₀ is used as MVᵥᵢᵣₜᵤₐₗ and the module MS is left.

Otherwise, a motion vector mv(S) is initialized in module MS for the at least one sub-set

S={sₜ|sₜε{MV₁,MV₂, . . . ,MV₈,}; sₘ≈sₙ,∀sₘ sₙεS; |S|≧c}.

The motion vector mv(S) can be initialized as the average value of all the motion Vectors: in sub-set S or as a cluster centre motion vector, for instance. Then execute the next three steps one by one to modify the value of mv(S).

Then, a local search area in the reference frame is defined. For example, said local search area being centred at mv(S) and extends +/−−δ^{x} around MV(S) along the x-axis and +/−δ^{y} around MV(S) along the y-axis but other local search areas are possible. In this case the local search area is a rectangle of size of 4*δ^{x}*δ^{y}. Within this local search area a best match is search which minimizes the difference with respect to the current block.

In case there is only a single sub-set comprising at least a one motion vector which is not similar to the full search result, the best match in a local search area determined using said single sub-set is used as MVᵥᵢᵣₜᵤₐₗ.

In case there is more than one sub-sets each comprising at least a one motion vector which is not similar to the full search result, the differences of the best matches of the more than one sub-sets are compared and the minimum among these best matches is used as MVᵥᵢᵣₜᵤₐₗ.

In case, MVᵥᵢᵣₜᵤₐₗ is determined for temporal distortion based QoE or RDO, the corresponding difference with respect to the current block, e.g. its distance to, is used as a temporal distortion TDV.

An embodiment exemplarily depicted in FIG. 3 comprises module SN which, prior to execution of modules ME and MS to a block of a decoded video frame, checks whether a great temporal distortion is semantically natural by applying modules ME and MS to a corresponding block of the original of the decoded video frame. If the difference between the block of the original and the block referenced by the virtual motion vector determined for this block of the original exceeds a threshold, this can be used as an indication that the smoothness constraint does not hold for this block in the original frame, for example, in case there is an integrated rigid-motion-object inside the block, or the current frame is the start of a new scene.

Thus, in case the smoothness constraint is violated for this original frame block, already, the temporal distortion TDV of the corresponding block of the decoded video frame needs not to be determined or can be defined as being Zero.

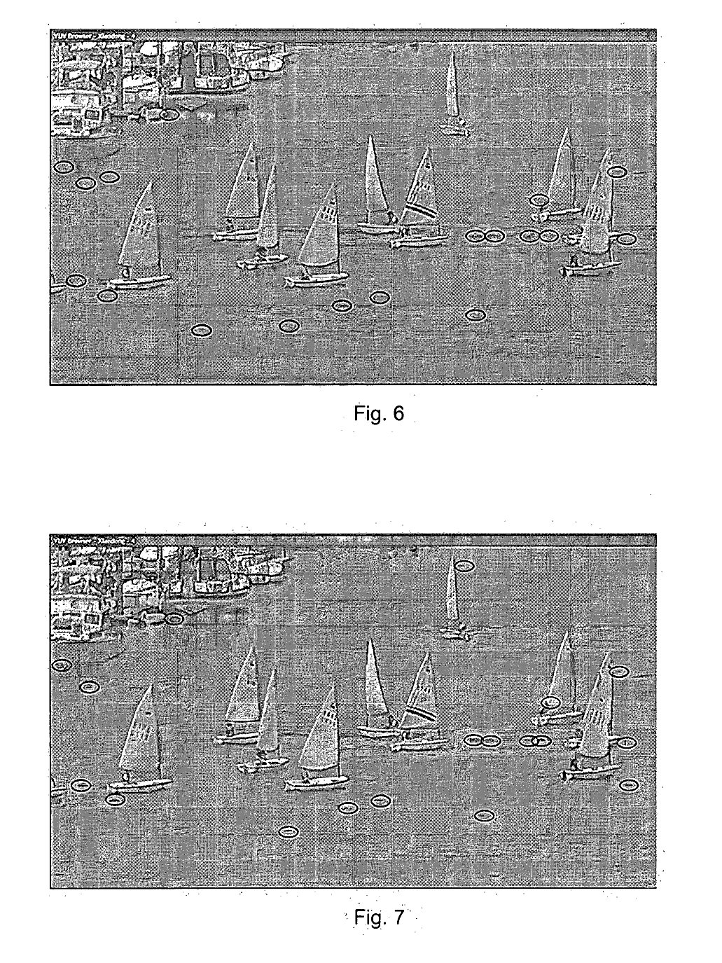

FIG. 6 gives an example, a frame of video sequence “Optis”. The video is compressed by H.264, IBBP . . . structure, QP=40. In FIG. 6 the blocks which can be perceived clear temporal distortion, are subjectively marked with circles. In FIG. 7, the blocks considered by the proposed evaluation scheme to be temporal distorted are marked with circles.

As can be judged from the example, the estimation is quite accurate. Blocks in the sailing boat with clear in-coherent motion vectors are not estimated to be of higher temporal distortion, because it is picked out by the check module SN as shown in FIG. 3.

Applying the proposed temporal quality evaluation scheme in codec, e.g. RDO or motion estimation, can help to increase human pleasure in perceiving the video.

In this document, a method for motion estimation, a method to detect and evaluate temporal distortion caused, by block based codec, such as H.264, and a method for using at least one of the motion estimation result and the temporal distortion result for QoE are proposed. The method for evaluating temporal distortion first tries to find blocks whose motion vectors are incoherent among its neighbourhood. Then a virtual motion vector which is coherent with the neighbourhood. With this virtual motion vector and motion compensation, a virtual block can be determined for which the human brain will not perceive any temporal distortion if it would be used in the current frame instead of the current block. Thus, the difference between the current block and the virtual block is indicative of a temporal distortion level.

In the proposed temporal distortion evaluation method, the un-distorted video is used as a reference. Therefore it is a full reference (FR) method. Within the proposed temporal distortion evaluation method, the further proposed method for determining a motion vector is applied on both, distorted- and un-distorted (reference) video. If a block in the un-distorted (reference) video is estimated to be of certain temporal distortion exceeding a threshold, the corresponding block in the distorted video is considered “semantically natural” and marked as no temporal distortion even if its motion vector is in-coherent with those of neighbouring blocks.

1-10. (canceled)

11. Method for determining a motion vector for a current block of a current video frame, said method comprising the steps of
determining the motion vector using full search over an entire reference video frame as search region for a global best match of the current block,
counting a number of further motion vectors for further blocks neighbouring the current block wherein only those further motion vectors are counted which are similar to the motion vector and which are further similar to each other,
ascertaining that the number meets or exceeds a threshold and that the motion vector is not similar to at least one of the counted further motion vectors, and
using the counted further motion vectors for determining a further search region, searching, in the further search region, a local best match of the current block and changing the motion vector towards referencing the local best match, the further search region being determined such that all candidates for the local best match are referenced by motion vector candidates similar to a yet further motion vector pointing to a centre of the further search region.

12. Method according to claim 11, wherein two motion vectors are judged similar in case that absolute differences of projections of the two motion vectors on a two perpendicular axes are smaller than further thresholds.

13. Method according to claim 11, wherein a best match has a minimal structural or statistical difference to the current block of all reference blocks in a respective search region.

14. Method according to claim 11, wherein the current video frame and the reference video frame result from decoding a compress-encoded bit stream in a decoding device, the method further comprising
assigning, to the current block, the difference of the current block to the block referenced by the determined motion vector as a temporal distortion value.

15. Method according to claim 14, wherein the compress-encoded bit stream further comprises a flag bit indicating that the temporal distortion value shall be assigned to the current block.

16. Method according to claim 15, wherein the flag bit is set by an encoding device in which the following steps are performed:
compress-encoding originals of the current video frame and the reference video frame of the current video frame in the bit stream,
determining a yet further motion vector for an original block of the current block,
ascertaining that the difference of the original block to the block referenced by the determined yet further motion vector does not exceed a yet further threshold.

17. Method according to claim 14, wherein the temporal distortion value is used for evaluation of a quality of experience of a video comprising the current video frame.

18. Method according to claim 11, wherein the motion vector is used for encoding the current block and wherein the further blocks neighbouring the current block are already encoded.

19. Device for determining a motion vector for a current block of a current video frame, said device being adapted for performing the method of claim 11.

20. Non-transitory storage medium carrying an encoded video comprising a current frame wherein at least some blocks of the current video frame are encoded according to the method of claim 18.
